(19) United States
(12) Patent Application Publication
(10) Pub. No.: US 2026/0036534 A1
(43) Pub. Date: Feb. 5, 2026

(54) PROCESSING APPARATUS, SYSTEM, METHOD AND PROGRAM

(71) Applicant: Rigaku Corporation, Tokyo (JP)

(72) Inventor: Takumi OTA, Tokyo (JP)

(73) Assignee: Rigaku Corporation, Tokyo (JP)

(21) Appl. No.: 19/265,209

(22) Filed: Jul. 10, 2025

(30) Foreign Application Priority Data
Jul. 31, 2024 (JP) 2024-124422

(51) Int. Cl. G01N 23/2055; G01N 23/207

(52) U.S. Cl. CPC G01N 23/2055; G01N 23/207

(57) ABSTRACT

A processing apparatus for performing non-negative matrix factorization to measured profiles of X-ray powder diffraction includes a measured profile acquiring section for acquiring a plurality of measured profiles; a decomposition section for applying non-negative matrix factorization to the measured profiles and calculating base profiles; an index calculating section for acquiring the base profiles and calculating indexes based on unevenness of the base profiles; a base profile classifying section for classifying the base profiles into a plurality of groups based on the indexes; and a base profile correcting section for performing correction based on the indexes on at least one of the plurality of groups and calculating a corrected base profile.

### CROSS-REFERENCE TO RELATED APPLICATION

This application claims priority from Japanese Patent Application No. 2024-124422 filed on Jul. 31, 2024, the entire contents of which are incorporated herein by reference.

### FIELD

The present disclosure relates to a processing apparatus, a system, a method, and a program.

### DESCRIPTION OF RELATED ART

X-ray powder diffraction is used in various fields. By analyzing the measured profile of the X-ray powder diffraction, for example, it is possible to identify (qualitative analysis) and quantify the constituents of the powder sample. Conventionally, crystalline phases have been identified by comparing the measured profile or d-I list generated from the measured profile with diffractive patterns of known materials.

Patent Document 1 discloses a crystalline phase identification method for identifying a crystalline phase contained in a sample from a powder diffraction pattern of the sample using a database, the crystalline phase identification method comprising {a whole pattern fitting step of performing whole pattern fitting on a first diffraction pattern, which is a powder diffraction pattern of the sample, using information of crystalline phase contained in the sample to calculate a theoretical diffraction pattern of the already identified crystalline phase}; {a residual information generating step of generating residual information of the sample based on a difference between the theoretical diffraction pattern and the first diffraction pattern}; and {a residual information search/match step for selecting a new crystalline phase contained in the sample by comparing the residual information with the database}.

Patent Document 2 discloses a spectrum data analyzer that obtains a plurality of base spectrum data and activation data representing a magnitude of each base spectrum by applying non-negative matrix factorization to a set of observed spectrum data obtained for a signal to be analyzed, the spectrum data analyzer obtaining the plurality of base spectrum data and the activation data by searching a degree of deviation between a set of observation spectrum data and a set of estimated spectrum data calculated from the plurality of base spectrum data and the activation data and a minimum value of values of an objective function including regularization term for evaluating a primary independence of the plurality of base spectrum data or the activation data.

### Patent Document

Patent Document 1: JP 2014-178203 A
Patent Document 2: JP 2019-87042 A

### SUMMARY

In the measured profile of X-ray powder diffraction, when many types of mixtures or an amorphous profile is included, there is much overlap of peaks of each profile. However, in such cases, if the methods described in Patent Document 1 in which search/match is performed using a d-I list as in the related art without processing the measured profile are applied, the accuracy of the qualitative analyses deteriorates.

Further, the technique disclosed in Patent Document 2 increases the accuracy of decomposition by taking into account the assumption that the independence among profiles is high. However, the amorphous profile does not have a sharp peak unlike the crystalline profile and is often a broad profile. Therefore, when some profiles are broad, such as when an amorphous profile is included in the measured profile, if a combination with high primary independence is searched by imposing regularization on the primary independence, there is a high risk of the decomposition accuracy decreasing, and the accuracy of subsequent qualitative analysis and quantitative analysis is deteriorated.

As a result of intensive research, the present inventors have found that, when a broad profile is included in measured profiles of X-ray powder diffraction, the accuracy of decomposition and the accuracy of subsequent qualitative analysis and quantitative analysis become higher than that of simply non-negative matrix factorization by applying non-negative matrix factorization to the measured profiles and correcting at least some of the base profiles.

The present disclosure has been made in view of such circumstances, and an object thereof is to provide a processing apparatus, a system, a method and a program capable of improving the accuracy of decomposition by applying non-negative matrix factorization to measured profiles of X-ray powder diffraction and correcting at least some of the base profiles.

(1) In some implementations, the processing apparatus of the present disclosure is a processing apparatus for applying non-negative matrix factorization to measured profiles of X-ray powder diffraction, the processing apparatus comprising a measured profile acquiring section for acquiring a plurality of measured profiles, a decomposition section for applying non-negative matrix factorization to the measured profiles and calculating base profiles, an index calculating section for acquiring the base profiles and calculating indexes based on unevenness of the base profiles, a base profile classifying section for classifying the base profiles into a plurality of groups based on the indexes, and a base profile correcting section for performing correction based on the indexes on at least one of the plurality of groups and calculating corrected base profiles.

(2) Further, in the processing apparatus of the present disclosure, the decomposition section applies non-negative matrix factorization to the measured profiles using the corrected base profiles as an initial condition.

(3) Further, in the processing apparatus of the present disclosure, the indexes are RTVs (relative total variations).

(4) Further, in the processing apparatus of the present disclosure, the plurality of groups are two groups, and the group for performing correction based on the indexes is a group including the base profile derived from an amorphous material.

(5) Further, the processing apparatus of the present disclosure further comprises a number-of-profiles setting section for setting a number of the base profiles included in a group that performs correction based on the indexes.

(6) Further, in the processing apparatus of the present disclosure, one of the corrections performed by the base profile correcting section is a correction in which the RTVs are reduced.

(7) Further, the processing apparatus of the present disclosure further comprises a dendrogram generating section for calculating a statistic among the plurality of measured profiles to generate a dendrogram, wherein the decomposition section applies non-negative matrix factorization to a cluster including a group of similar profiles selected by the processing apparatus from the dendrogram or selected by a user.

(8) Further, the processing apparatus further includes a peak search section that performs a peak search on the base profile after the non-negative matrix factorization and generates a d-I list, and an identification section that performs a qualitative analysis using d-I list.

(9) Further, the processing apparatus of the present disclosure further includes a quantification section that performs quantitative analysis using the qualitatively analyzed data.

(10) Further, the system of the present disclosure comprises an X-ray diffraction apparatus comprising an X-ray generation section for generating X-rays, a detector for detecting X-rays and a goniometer for controlling the rotation of the sample, and the processing apparatus according to any one of (1) to (9).

(11) Further, the method of the present disclosure is a method for applying non-negative matrix factorization to measured profiles of X-ray powder diffraction, the method comprising acquiring a plurality of measured profiles, applying non-negative matrix factorization to the measured profiles and calculating base profiles, acquiring the base profiles and calculating indexes based on unevenness of the base profiles, classifying the base profiles into a plurality of groups based on the indexes, and performing correction based on the indexes on at least one of the plurality of groups and calculating corrected base profiles.

(12) Further, the program of the present disclosure is a program for performing non-negative matrix factorization to measured profiles of X-ray powder diffraction, the program causing a computer to perform acquiring a plurality of measured profiles, applying non-negative matrix factorization to the measured profiles and calculating base profiles, acquiring the base profiles and calculating indexes based on unevenness of the base profiles, classifying the base profiles into a plurality of groups based on the indexes, and performing correction based on the indexes on at least one of the plurality of groups and calculating corrected base profiles.

### BRIEF DESCRIPTION OF THE DRAWINGS

FIG. 1 is a conceptual diagram showing the manner of non-negative matrix factorization.

FIG. 2 is a schematic diagram showing an example of a configuration of the X-ray diffraction measuring system.

FIG. 3 is a block diagram showing an example of a configuration of the control apparatus and the processing apparatus.

FIG. 4 is a block diagram showing a modified example of a configuration of the control apparatus and the processing apparatus.

FIG. 5 is a block diagram showing a modified example of a configuration of the control apparatus and the processing apparatus.

FIG. 6 is a block diagram showing a modified example of the configuration of the processing apparatus.

FIG. 7 is a block diagram showing a modified example of the configuration of the processing apparatus.

FIG. 8 is a block diagram showing a modified example of the configuration of the processing apparatus.

FIG. 9A is a schematic diagram showing an example of UI for setting or the like of a function of component analysis.

FIG. 9B is a schematic diagram describing a function of a part of UI of component analysis.

FIG. 10 is a schematic diagram showing an example of UI for setting or the like of generating a dendrogram.

FIG. 11 is a schematic diagram showing an example of UI for setting or the like of a search/match function and a quantitative analysis function.

FIG. 12 is a flowchart showing an example of the operation of the processing apparatus.

FIG. 13 is a flowchart showing a modified example of the operation of the processing apparatus.

FIG. 14 is a flowchart showing a modified example of the operation of the processing apparatus.

FIG. 15 is a flowchart showing a modified example of the operation of the processing apparatus.

FIGS. 16A and 16B are graphs showing decomposed base profiles of Example 1 and Comparative Example 1, respectively.

FIGS. 17A, 17B, and 17C are graphs showing the true content ratios of Samples 91 to 101, the analysis results according to Example 1, and the analysis results according to Comparative Example 1, respectively.

FIG. 18 is a graph showing time changes in temperature and humidity of an environment in which samples of Example 2 and Comparative Example 2 are placed.

FIG. 19 is a graph showing the base profiles of amorphous materials of Example 2 and Comparative Example 2, respectively.

FIGS. 20A and 20B are graphs showing the analysis results according to Example 2 and the analysis results according to Comparative Example 2, respectively.

### DETAILED DESCRIPTION

Next, embodiments of the present disclosure are described with reference to the drawings. To facilitate understanding of the description, the same reference numerals are assigned to the same components in the respective drawings, and duplicate descriptions are omitted.

### [Principle]

A measured profile of X-ray powder diffraction includes profiles and a background of a plurality of substance. When many types of mixtures or an amorphous profile is included, there is much overlap of peaks of each profile. In such cases, the accuracy of the peak search is lowered, and conventional search/match performed using the d-I list is often not suitable.

Non-negative matrix factorization (NMF: Non-negative Matrix Factorization) indicates decomposing a non-negative matrix into the product of non-negative matrices. To facilitate the search/match, decomposition of the measured profile of the X-ray powder diffraction into a weighted sum of multiple profiles (which may include background profiles) is considered. Since each profile and its weights are both non-negative values, non-negative matrix factorization is suitable for representing the measured profile of X-ray powder diffraction as a weighted sum of a plurality of profiles.

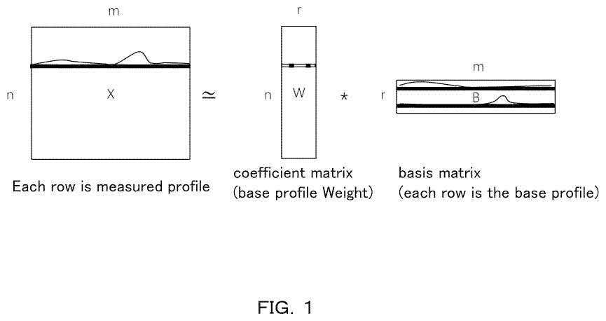

FIG. 1 is a conceptual diagram showing the manner of non-negative matrix factorization. The left side of FIG. 1 shows a matrix obtained by arranging n measured profiles of X-ray powder diffraction with m measurement points. The result obtained by applying non-negative matrix factorization to the left side is the right side of FIG. 1. However, the equal symbol with waved line in FIG. 1 includes not only an exact match but also a case where the degree of deviation indicating the degree of the neighborhood between the left side and the right side is a predetermined value or less.

The measured profile of X-ray powder diffraction may comprise a broad profile. The case where a broad profile is included refers to, for example, a case where amorphous profile is included. In such a case, if a non-negative matrix factorization is performed in which a combination with high primary independence is searched for by imposing regularization on primary independence as in Patent Document 1, the accuracy of a subsequent search/match may deteriorate, which is not appropriate.

The method of the present disclosure corrects at least some of the base profiles obtained by performing non-negative matrix factorization to the measured profiles when the measured profiles of the X-ray powder diffraction include a broad profile. The corrections are made for some base profiles that are considered more accurate to be broad, so as to smooth out the unevenness of the profile. The method of the present disclosure can accurately perform non-negative matrix factorization when a broad profile is included in measured profiles, and the accuracy of subsequent qualitative analysis and quantitative analysis is increased. It should be noted that although various methods have been proposed for applying non-negative matrix factorization to a given non-negative matrix, the present disclosure can use a general method. The detailed method according to the present disclosure is detailed in the embodiment.

### Embodiment

### [Whole System]

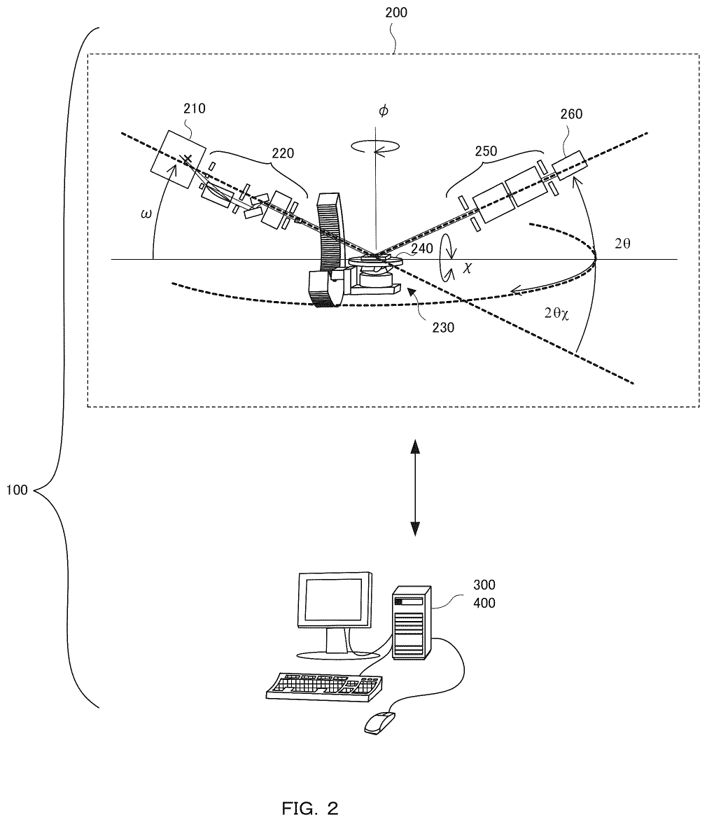

FIG. 2 is a schematic diagram showing an example of a configuration of an X-ray diffraction measurement system 100. The system 100 includes an X-ray diffraction apparatus 200, a control apparatus 300, and a processing apparatus 400. The X-ray diffraction apparatus 200 makes X-rays incident on a sample and constitutes an optical system for detecting diffracted X-rays generated from the sample, and the optical system comprises a goniometer. Incidentally, the configuration shown in FIG. 2 is one example, and thus a variety of other configurations may be adopted.

The control apparatus 300 is connected to the X-ray diffraction apparatus 200 and controls the X-ray diffraction apparatus 200 and processes and stores the acquired data. The processing apparatus 400 applies non-negative matrix factorization to the measured profiles of the X-ray powder diffraction and corrects at least some of the base profiles. The control apparatus 300 and the processing apparatus 400 are apparatuses including CPU and memories and may be PC terminals or servers on the cloud. Not only the whole apparatus but also part of the apparatus or some functions of the apparatus may be provided on the cloud. The input device 510 is, for example, a keyboard or a mouse, and performs input to the control apparatus 300 or the processing apparatus 400. The display device 520 is, for example, a display, and displays a measured profile, a result of non-negative matrix factorization, and the like.

Using such a system 100, the profile of the X-ray powder diffraction can be measured, the measured profiles can be applied non-negative matrix factorization, and at least some of the base profiles can be corrected. In addition, it is possible to perform qualitative analysis or quantitative analysis using the base profiles obtained by performing non-negative matrix factorization and correcting at least some of the base profiles.

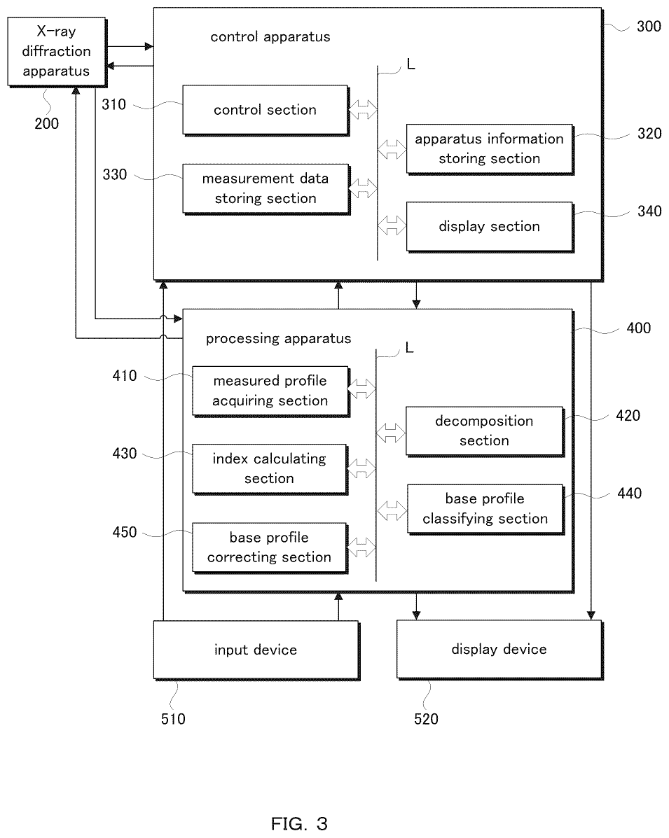

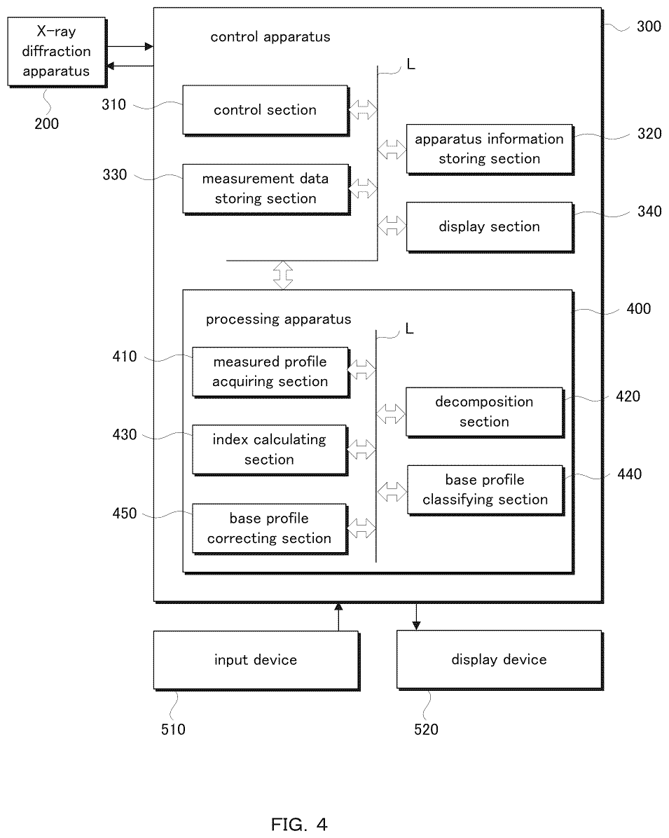

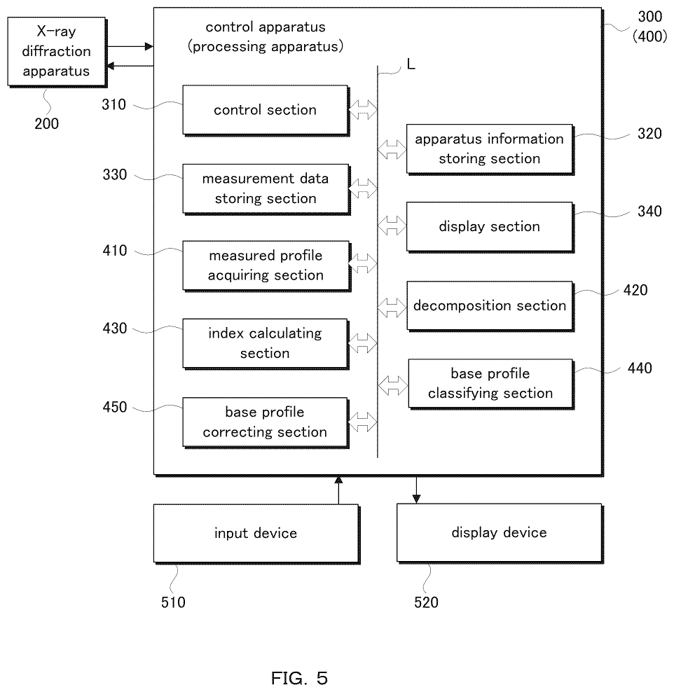

In FIG. 2, the control apparatus 300 and the processing apparatus 400 are described as the same PC. However, the method of the present disclosure enables obtaining measured profiles and correcting at least some of the base profiles obtained by non-negative matrix factorization, regardless of the X-ray diffraction apparatus 200 or the control apparatus 300. Therefore, as shown in FIG. 3, the processing apparatus 400 may be configured as an apparatus different from the control apparatus 300. FIG. 3 is a block diagram showing an example of a configuration of the control apparatus 300 and the processing apparatus 400. Further, as shown in FIG. 4, the processing apparatus 400 may be configured as a part of functions included in the control apparatus 300. As shown in FIG. 5, the processing apparatus 400 and the control apparatus 300 may be configured as an integrated apparatus. FIG. 4 and FIG. 5 are block diagrams showing modified examples of the configurations of the control apparatus 300 and the processing apparatus 400. Hereinafter, a case where the control apparatus 300 and the processing apparatus 400 are configured as different apparatuses is described.

### [X-ray Diffraction Apparatus]

The X-ray diffraction apparatus 200 comprises an X-ray generation section 210 that generates X-rays from an X-ray focus, that is, an X-ray source; an incident side optical unit 220; a goniometer 230; a sample table 240 where a sample is set; an emitting side optical unit 250; and a detector 260 that detects X-rays. The X-ray generation section 210, the incident side optical unit 220, the goniometer 230, the sample table 240, the emitting side optical unit 250, and the detector 260 each constituting the X-ray diffraction apparatus 200 may be those generally available, and thus descriptions are omitted.

### [Control Apparatus]

The control apparatus 300 is constituted from a computer formed by connecting CPU (Central Processing Unit/Central Processor), ROM (Read Only Memory), RAM (Random Access Memory) and a memory to a bus. The control apparatus 300 is connected to the X-ray diffraction apparatus 200 to receive information.

The control apparatus 300 comprises a control section 310, an apparatus information storing section 320, a measurement data storing section 330 and a display section 340. Each section can transmit and receive information via the control bus L. The input device 510 and the display device 520 are connected to CPU via an appropriate interface.

The control section 310 controls the operations of the X-ray diffraction apparatus 200. The apparatus information storing section 320 stores apparatus information acquired from the X-ray diffraction apparatus 200. The apparatus information includes information about the X-ray diffraction apparatus 200 such as name of the apparatus, the kind of a radiation source, a wavelength, a background, and so forth. In addition, information necessary for correcting the base profiles, such as a Gaussian filter, a method of polynomial approximation, and a method of TV regularization, and information necessary for applying non-negative matrix factorization to the measured profiles of X-ray powder diffraction, such as the type of constituent elements and composition of the sample may be included.

The measurement data storing section 330 stores the measured profile acquired from the X-ray diffraction apparatus 200. Together with the measured profile, information necessary for correcting the base profiles, such as source type, wavelength, background, type of constituent element of the sample, composition of the sample, etc., and information necessary for applying non-negative matrix factorization to the measured profile of the X-ray powder diffractometer, such as Gaussian filters, methods of polynomial approximation, methods of TV regularization, etc., may be included. The display section 340 causes the display device 520 to display the measured profile and the base profiles. Thus, the measured profile and the base profiles can be confirmed by the user. In addition, the user can provide instruction and designation to the control apparatus 300, the processing apparatus 400, and the like based on the measured profile or the base profiles.

### [Processing Apparatus]

The processing apparatus 400 is configured from a computer formed by connecting CPU, ROM, RAM and a memory to a bus. The processing apparatus 400 may be connected to the X-ray diffraction apparatus 200 via the control apparatus 300.

The processing apparatus 400 includes a measured profile acquiring section 410, a decomposition section 420, an index calculating section 430, a base profile classification section 440, and a base profile correcting section 450. Each section can transmit and receive information via the control bus L. When the processing apparatus 400 is a separate configuration from the control apparatus 300, the input device 510 and the display device 520 are also connected to CPU of the processing apparatus 400 via an appropriate interface. In this case, the input device 510 and the display device 520 each may differ from one connected to the control apparatus 300.

The measured profile acquiring section 410 acquire measured profiles. The measured profile acquiring section 410 may acquire the measured profile from the X-ray diffraction apparatus 200 directly or via the control apparatus 300. In addition to the measured profile, the measured profile acquiring section 410 may acquire information necessary for applying non-negative matrix factorization to the measured profile of the X-ray powder diffraction, such as the type of the source, the wavelength, the background, the type of constituent elements of the sample, and the composition of the sample, or information necessary for correcting the base profiles, such as a Gaussian filter, a polynomial approximation method, a TV regularization method, and the like. These pieces of information may be stored in a storage section of the processing apparatus 400.

The decomposition section 420 applies non-negative matrix factorization to the measured profiles and calculates the base profiles. A matrix with N rows and M columns in which N measured profiles of X-ray powder diffraction having M measurement points are arranged is denoted by X. At this time, the non-negative matrix factorization of X is expressed by the following Equation (1). W is a coefficient matrix, and B is a basis matrix. W represents the weight of B. Each row of the basis matrix B is a base profile (basis vector). Further, R is a hyper parameter indicating the number of base profiles. M, N and R denote the maximum value of the variable, and m, n and r denote the variable.

$$\begin{matrix}[ formula 1 ] & \\ X ( n , m ) ≅ {\sum }_{r} W ( n , r ) * B ( r , m ) & ( 1 )\end{matrix}$$

For the non-negative matrix factorization, a method such as an alternating least squares method, a multiplicative update method, a coordinate descent method and the like plus regularization can be applied. As regularization, the sparsity of the profiles to be decomposed or the weights can be imposed.

The decomposition section 420 preferably applies non-negative matrix factorization to the measured profiles using the corrected base profiles as an initial condition. The non-negative matrix factorization of the measured profiles using the corrected base profiles as an initial condition is to update the coefficient matrix W with respect to a matrix in which a part of the rows of the basis matrix B is replaced with the corrected base profiles, and to update the basis matrix B with respect to the updated coefficient matrix W, thereby applying the non-negative matrix factorization to the measured profiles.

The index calculating section 430 acquires a base profile and calculates an index based on the unevenness of the base profile. The index may be by any definition but can represent the feature of the unevenness of the base profile and make the feature a comparable index. Accordingly, the base profiles can be classified into a plurality of groups according to the unevenness of the base profiles as the features.

Preferably, the index is RTV (Relative Total Variation). RTV is an index generally defined by the following formula (2) with respect to the function f. RTV is a representative indicator that can well characterize the unevenness of the function. For the basis matrix B(r,m) described above, when the base profile of the rth row of the basis matrix B(r,m) is expressed as Br (m) as shown in formula (3) below, the base profile is defined by formula (4) below.

$$\begin{matrix}[ formula 2 ] & \\ RTV = \frac{‖ ∇ f ‖}{‖ f ‖} & ( 2 )\end{matrix}$$

$$\begin{matrix}[ formula 3 ] & \\ {B}_{r} ( m ) = B ( r , m ) & ( 3 )\end{matrix}$$

$$\begin{matrix}[ formula 4 ] & \\ RTV ( r ) = \frac{‖ ∇ {B}_{r} ( m ) ‖}{‖ {B}_{r} ( m ) ‖} & ( 4 )\end{matrix}$$

The indicator is preferably a RTV, but other indicators can be used as long as they can characterize the unevenness of the base profile. For example, it can be evaluated from the amount of displacement before and after the smoothing process is performed on the base profile, the number of peaks when the peak search is performed on the base profile, the half-value width, and the integrated intensity, or it can be evaluated by a combination of these indexes.

The base profile classification section 440 classifies the base profiles into a plurality of groups based on the indexes calculated by the index calculating section 430. The classification of the base profiles can be performed, for example, by setting a plurality of numerical ranges that do not overlap each other in the index and classifying the base profile having the value of the index of the numerical range as the base profile belonging to the group of the numerical range. Also, the classification of the base profiles can be performed using the K-means clustering based on the indexes.

It is preferable that the plurality of groups is two groups, and the group for performing the index-based correction is a group including a base profile derived from an amorphous material. Accordingly, it is possible to perform correction based on the index for the base profile derived from the amorphous material.

The base profile correcting section 450 performs an index-based correction on at least one of the plurality of groups classified by the base profile classifying section 440 and calculates a corrected base profile. The base profile correcting section 450 may respectively perform correction on two or more groups among the plurality of classified groups. In addition, correction may be performed for all groups, respectively. In these cases, each correction includes a different one.

When the index is a RTV, it is preferable that one of the corrections performed by the base profile correcting section 450 is a correction in which the RTV is reduced. Thus, for example, a base profile such as an amorphous profile, which is closer to the actual profile when the RTV is smaller, can be corrected to be closer to the actual profile. Even in the case an index other than RTV is used, when an index whose absolute value decreases when the unevenness of the base profile is small is used, it is preferable that one of the corrections performed by the base profile correcting section 450 is correction in which the absolute value of the index decreases as described above.

The correction that reduces the RTV value may be any type. Specifically, it is possible to use for the correction, for example, smoothing using a filter such as a Gaussian filter, a polynomial approximation using a low-order polynomial, for example, a polynomial of a fifth order or less, a TV regularization, or the like.

With such a configuration, when a broad profile is included in the measured profiles of the X-ray powder diffraction, at least some of the base profiles obtained by applying non-negative matrix factorization to the measured profile It is preferable that the plurality of groups is two groups, and the group for performing the index based correction is a group including a base profile derived from an amorphous material. can be corrected, and the accuracy of the decomposition can be increased.

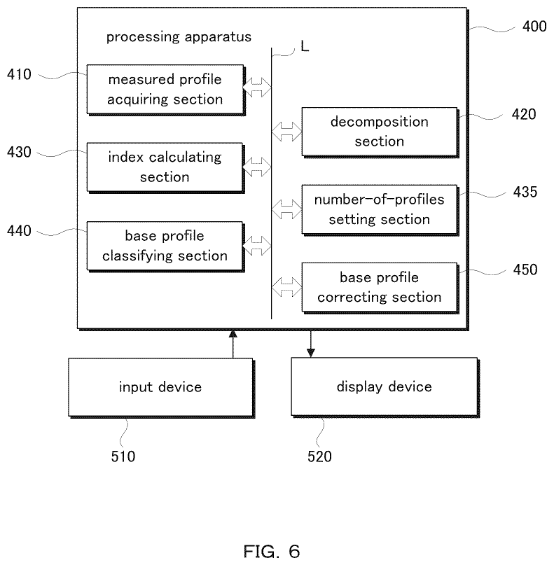

FIG. 6 is a block diagram showing a modified example of the configuration of the processing apparatus 400. As shown in FIG. 6, the processing apparatus 400 preferably comprises a number-of-profiles setting section 435. The number-of-profiles setting section 435 sets the number of base profiles included in the group for performing correction based on the index. The number of profiles set by the number-of-profiles setting section 435 is a value smaller than the value of the hyper parameter R.

The number-of-profiles setting section 435 preferably sets the number of base profiles included in the group for performing the correction based on the index based on the index calculated by the index calculating section 430 or according to an instruction from the user. When the number-of-profiles setting section 435 sets the number of base profiles included in the group for performing index-based correction, the base profile classifying section 440 classifies the set number of base profiles into the group for performing index-based correction. Accordingly, even when two or more broad profiles are included in the measured profile, the base profiles corresponding to these profiles can be appropriately corrected, and the accuracy of the decomposition can be further increased.

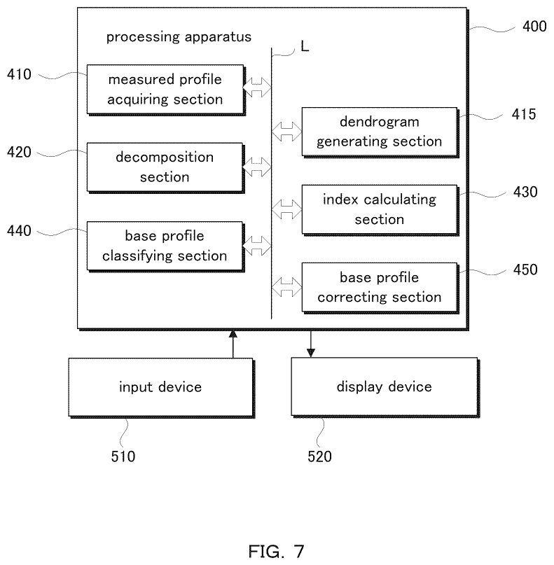

FIG. 7 is a block diagram showing a modified example of the configuration of the processing apparatus 400. As shown in FIG. 7, the processing apparatus 400 preferably comprises a dendrogram generating section 415. The dendrogram generation section 415 calculates a statistic among a plurality of measured profiles and generates a dendrogram.

When the dendrogram generation section 415 generates a dendrogram, the decomposition section 420 preferably applies non-negative matrix factorization to a cluster including similar profile groups selected from the generated dendrograms by the processing apparatus 400 or by the user.

By calculating statistics among measured profiles for a plurality of measured profiles, generating a dendrogram and selecting a cluster including a group with similar profiles from the generated dendrogram to perform non-negative matrix factorization, it is expected that a measured profile having a small possibility of including a characteristic profile common to each measured profile is excluded. As a result, non-negative matrix factorization can be accurately applied to a plurality of measured profiles.

FIG. 8 is a block diagram showing a modification of the configuration of the processing apparatus 400. As shown in FIG. 8, the processing apparatus 400 preferably includes a dendrogram generation section 415, a number-of-profiles setting section 435, a peak search section 460, an identification section 470, and a quantification section 480. The dendrogram generating section 415 and the number-of-profiles setting section 435 are functional sections similar to those described above.

The peak search section 460 performs peak search on the base profile after non-negative matrix factorization and generates a d-I list. The peak search is performed on one profile selected from the base profiles obtained by the non-negative matrix factorization. The selection of the base profile may be performed by the user or by the peak search section 460 or another functional section in the processing apparatus 400. In addition, a d-I list is generated for each base profile subjected to the peak search. The peak search is preferably performed on all profiles other than those determined to be background.

The identification section 470 performs qualitative analysis using the d-I lists. The qualitative analyses can be performed by performing search/match on the generated d-I lists. Qualitative analysis can be performed using known methods. Since the base profile after correction is expected to be more accurate than the base profile without correction, qualitative analysis using d-I lists generated from the corrected base profiles often facilitates identification of components or increases the accuracy of identification.

The quantification section 480 performs quantitative analysis using the qualitatively analyzed data. Quantitative analysis can be performed using known methods. In the configuration of FIG. 8, the dendrogram generation section 415, the number-of-profiles setting section 435, the peak search section 460, the identification section 470, and the quantification section 480 are arbitrary functional sections, and any one or more of them may be omitted.

With such a configuration, the measured profiles of the X-ray powder diffraction measured by the X-ray diffraction apparatus can be applied non-negative matrix factorization to correct some of the base profiles, which can be used for qualitative analysis and quantitative analysis.

### [User Interface]

When the parameters and the like are instructed to the processing apparatus 400 by the user, it is preferable to use a user interface (UI) function that allows various settings to be input by, for example, a mouse operation or a keyboard operation. The function of the processing apparatus 400 is preferably configured to cooperate with the function of another apparatus. Hereinafter, an example of UI for setting parameters to the processing apparatus 400 and an example of UI when the function of the processing apparatus 400 cooperates with the function of another apparatus are described. It is assumed that the functions of the processing apparatus 400 are implemented as software.

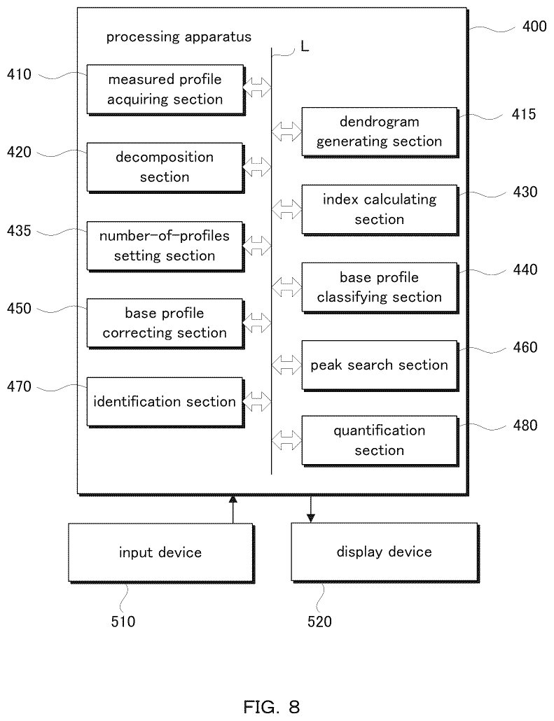

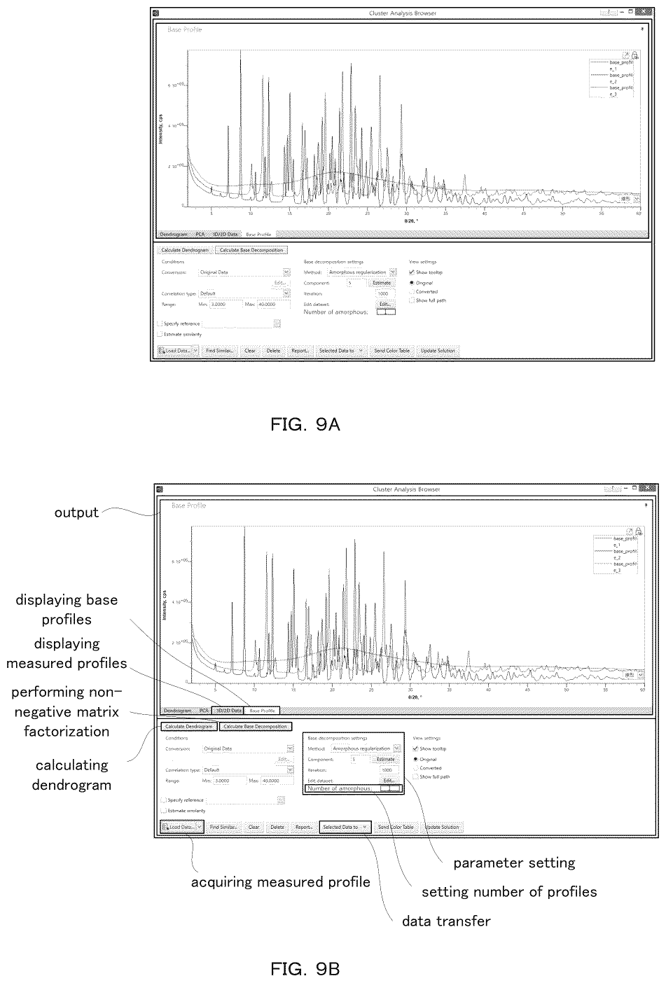

FIG. 9A is a schematic diagram showing an example of UI for setting or the like of a function of component analysis. Further, FIG. 9B is a schematic diagram describing a function of a part of a UI (UI in FIG. 9A) of component analysis. On the screen of FIG. 9A, a user may provide instructions to the processing apparatus 400 for acquiring measured profiles, setting parameters, setting numbers of profiles, calculating dendrograms, performing non-negative matrix factorization, displaying measured profiles, displaying base profiles, transferring data, etc. With the parameter setting panel, an optimization method of non-negative matrix factorization, hyper parameter values, number of iterations, regularization and the number of base profiles belonging to a group that performs index-based correction may be set. The value of the hyper parameter may be automatically estimated and set using the Akaike's information criterion, the Bayesian information criterion, or the like, or the estimated value may be displayed by Estimate button. The data resulting from non-negative matrix factorization is transferred to search/match and quantification functions with the Data Transfer button.

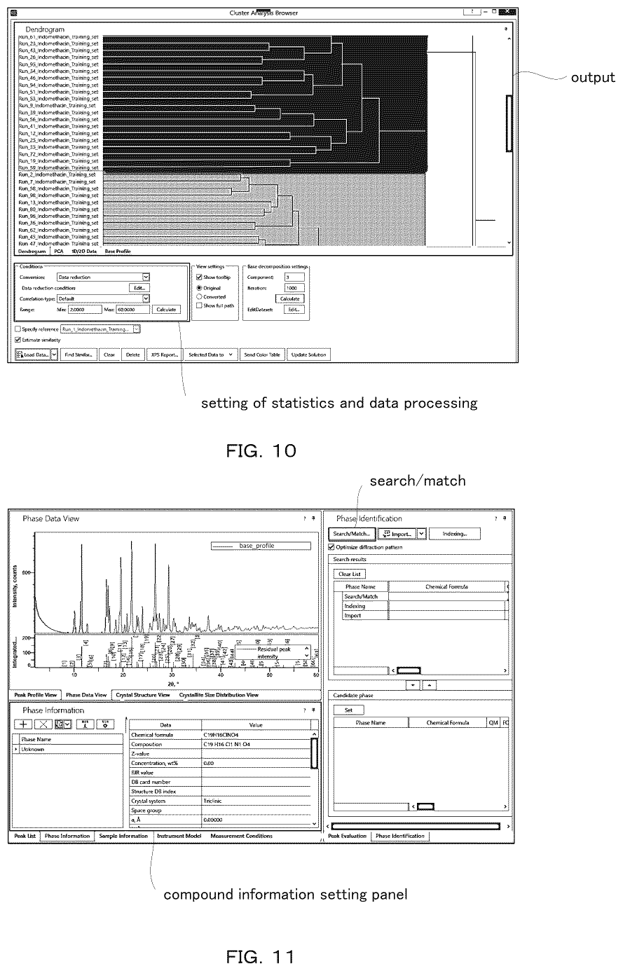

FIG. 10 is a schematic diagram showing an example of UI for setting or the like of generating a dendrogram. On the screen in FIG. 10, the user can give instructions to the processing apparatus 400 such as statistics for dendrogram generation, settings of data processing, cluster selection and the like.

FIG. 11 is a schematic diagram showing an example of UI for setting or the like of a search/match function and a quantitative analysis function. By pressing Data Transfer button on the screen in FIG. 9A, the screen in FIG. 11 is launched. On the screen in FIG. 11, the user can give an instruction to the processing apparatus 400 or other apparatus such as execution of search/match, setting of compound information and the like.

Note that the setting items and the like displayed in FIGS. 9A, 9B to FIG. 11 are exemplary, and even when the user sets them, all or only a part of them may be set. In addition, there may be setting items and functions that are not displayed in FIGS. 9A, 9B to 11.

### [Measurement Method]

A sample S is installed in the X-ray diffraction apparatus 200, and the goniometer is driven under a predetermined condition based on the control of the control apparatus 300. Further, X-rays are incident on the sample, and diffracted X-rays generated from the sample are detected. Thus, the diffraction data is acquired. The X-ray diffraction apparatus 200 transmits the apparatus information, etc. and the acquired diffraction data as the measurement data to the control apparatus 300.

### [Disassembly Method]

### (Description of the Basic Flow of Non-Negative Matrix Factorization)

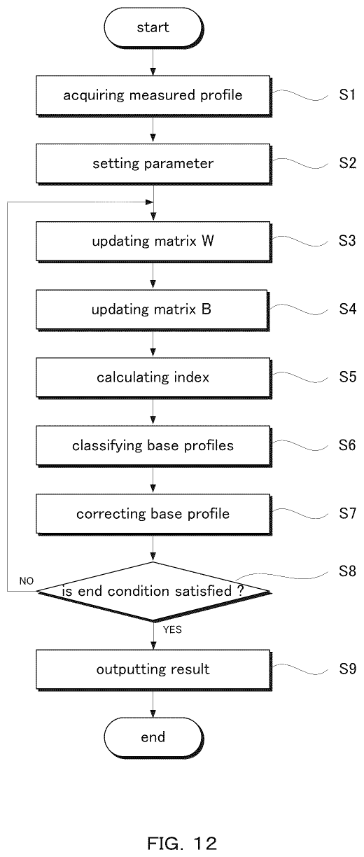

FIG. 12 is a flowchart showing an example of the operation of the processing apparatus 400. FIG. 12 shows an example of the basic operation of non-negative matrix factorization and the correction of base profile. First, the processing apparatus 400 acquire measured profiles (step S1). Next, the parameters are set (step S2). The parameters to be set are parameters necessary for optimization such as number of base profiles to be decomposed (a value of hyper parameter), an optimization method and the like. The parameters may be set as input by the user or may be determined and set by the processing apparatus 400 based on the measured profiles or the information related to the measured profiles.

Next, the matrix W is updated (step S3). Next, the matrix B is updated (step S4). The updating of the matrix W and the updating of the matrix B are performed by generating a matrix consisting of measured profiles and optimizing the coefficient matrix W and the basis matrix B. The updating of the matrix W and the updating of the matrix B include the initial setting and calculation. When there is a corrected base profile, updating of the matrix W and updating of the matrix B are performed by setting the corrected base profiles as a basis matrix and optimizing the coefficient matrix W and the basis matrix B. It may be said that the non-negative matrix factorization is performed by combining the updating of the matrix W and the updating of the matrix B.

Next, the indexes are calculated for the base profiles of respective rows of the basis matrix B (step S5). Next, the base profiles are classified into a plurality of groups (step S6). The classification of the base profiles is performed only in the first loop, and the first classification may be used as it is in the second and subsequent loops. Next, at least one of the plurality of groups is corrected based on the index (step S7). The base profile to which the correction has been applied is referred to as a corrected base profile. Next, it is determined whether or not the termination condition is satisfied (step S8). If the termination condition is not satisfied (step S8-NO), the process returns to step S3, the corrected base profiles are set as the basis matrix, and non-negative matrix factorization is performed.

On the other hand, if the termination condition is satisfied (step S8-YES), the result is output as needed (step S9), and the process ends. A configuration may be adopted in which only the result is stored and output when an instruction is given from the user. In this way, the non-negative matrix factorization can be applied to a plurality of measured profiles of X-ray powder diffraction to correct at least some of the base profiles.

As the termination conditions, various conditions can be adopted. For example, the number of times of loops may be set as the termination condition. Further, a change amount of the corrected base profile before and after the loop, change amounts of a part or all of the indexes, a change amount of a part or all of the coefficient matrix, a change amount of a part or all of the basis matrix, a degree of coincidence between one or more measured profiles and calculated profiles corresponding to them, and the like may be defined, and the threshold value thereof may be set to terminate the process when the amount or degree exceeds or falls below the threshold value. Note that the amount of change refers to the magnitude of change or the rate of change. Further, the calculated profile refers to one profile obtained by multiplying a certain row of a coefficient matrix corresponding to one measured profile by a basis matrix. Note that, for example, when a known profile is used as the initial value of the base profile, it may be expected that a result close to the target result can be obtained without performing loop processing. In such cases, the process may end up to step S7 in FIG. 12.

### (Description of Flow for Setting Number of Base Profiles)

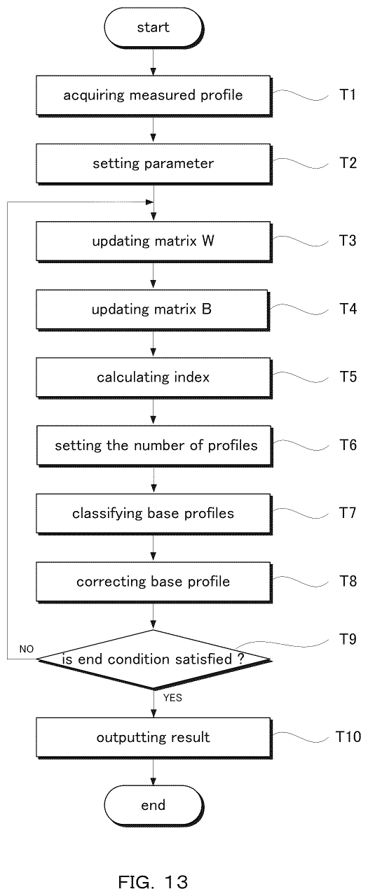

FIG. 13 is a flowchart showing a modified example of the operation of the processing apparatus 400. FIG. 13 shows an example of the operation in the case of setting the number of base profiles. In the following description of the flowchart, the characteristic operation is described in detail, and the description of the operation already described may be omitted. Steps T1 to T5 are the same as steps S1 to S5 described above. Next, the processing apparatus 400 sets the numbers of base profiles included in the group to be performed correction based on the index (step T6). If the number of base profiles is set based on the index, the number of base profiles needs to be set after step T5. In this case, in the second and subsequent loops, the setting of the number of base profiles is skipped. When the number of base profiles is not set based on the index, the number of base profiles may be set simultaneously with the setting of parameters, for example. Subsequent steps T7 to T10 are the same as the above-described steps S6 to S9.

### (Description of Flow in Generating Dendrogram)

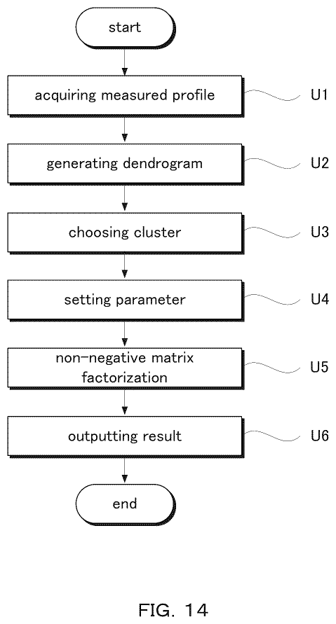

FIG. 14 is a flowchart showing a modified example of the operation of the processing apparatus 400. FIG. 14 shows an example of the operation when a dendrogram is generated. First, the processing apparatus 400 acquire measured profiles (step U1). The step U1 is similar to the step S1.

Next, dendrogram is generated (step S2). The dendrogram is generated by calculating statistics among the acquired plurality of measured profiles. Next, the cluster is selected (step U3). The cluster may be selected by the user or by the processing apparatus 400. By selecting the cluster being a group of similar profiles from the dendrograms, the accuracy of the decomposition is improved.

Next, the parameters are set (step U4). Next, non-negative matrix factorization is performed (step U5). Step U5 is a step in which steps S3 to S8 are integrated. Then, the result is output as needed (step U6), and the process ends. In this way, a dendrogram may be generated and a non-negative matrix factorization may be performed after selecting a cluster, and at least some of the base profiles can be corrected.

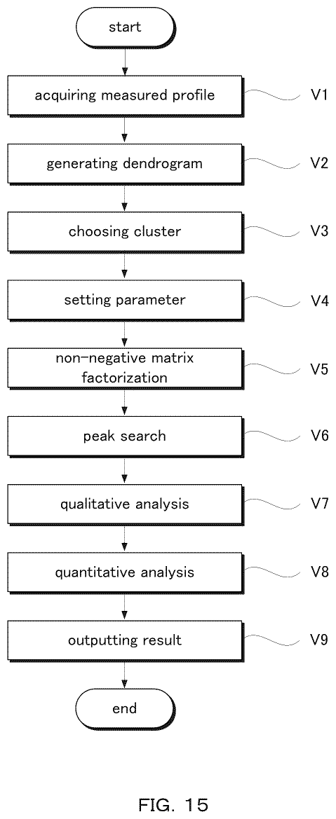

(Description of Flow of Modification in Qualitative Analysis or Further Quantitative Analysis) FIG. 15 is a flowchart showing a modified example of the operation of the processing apparatus 400. FIG. 15 shows a modified example of the operation in the case of performing a non-negative matrix factorization and performing a qualitative analysis or even a quantitative analysis after correcting at least some of the base profiles. From the step of acquiring the measured profiles (step V1) to the step of performing the non-negative matrix factorization (step V5) are similar to steps U1 to U5.

Next, peak search is performed (step V6). The peak search is performed on the selected one of the profiles obtained by applying non-negative matrix factorization to the base profiles. The selection of a base profile may be performed by the user or by the processing apparatus 400. In addition, a d-I list is generated for each base profile for which the peak search has been performed. The peak search is preferably performed on all base profiles other than the base profile determined to be background.

Next, qualitative analyses are performed (step V7). The qualitative analyses can be performed by performing search/match based on the generated d-I list. If a profile whose degree of coincidence is a predetermined value or more is not found as a result of the search/match, the process may return to step V4, and the non-negative matrix factorization may be performed again from the setting of the parameter.

Next, quantitative analysis is performed (step V8). In the quantitative analysis, the content ratio of the substance identified by the qualitative analysis is specified using various methods. For example, DD (Direct Derivation) method, RIR method, the Rietveld method or the like can be used. Then, the result is output as needed (step V9), and the process ends. In this way, a plurality of measured profiles of X-ray powder diffraction can be non-negative matrix factorized, and after at least some of the base profiles are corrected, qualitative analysis can be performed, and quantitative analysis can be performed using the qualitative analysis.

In the flowchart in FIG. 15, after the qualitative analysis of step V7, the result is output as needed (step V9) without performing the quantitative analysis, and the process may end. In this way, the qualitative analysis can be performed after the non-negative matrix factorization is applied to the plurality of measured profiles of the X-ray powder diffraction and at least some of the base profiles are corrected.

The order of the steps in each of the above-described flowcharts is not fixed, and the steps may be changed in order or processed in parallel as long as the process can be correctly performed. Each flowchart may be applied in combination with other flowcharts.

### Example, Comparative Example

### Example 1

X-ray diffraction data were measured for mixtures of indomethacin as samples 1-101 using a system 100 configured as described above. Base profiles of indomethacin α type, indomethacin y type and amorphous were calculated using the method of the present disclosure for the measured profiles corresponding to samples 1-90 of the measured samples. Specifically, each base profile was calculated by performing non-negative matrix factorization with the hyper parameter set to 3 and the termination condition set to 200 repetitions and correcting the base profile considered to be an amorphous profile.

### Comparative Example 1

For the same measured profiles, non-negative matrix factorization was performed by setting the hyper parameter to 3 using the alternating least squares method which is the conventional method, and the base profiles of indomethacin α type, indomethacin y type and amorphous were calculated.

FIGS. 16A and 16B are graphs showing the base profiles of Example 1 and Comparative Example 1, respectively. FIG. 16A shows that the base profile, which is considered to be an amorphous profile in the first embodiment, is broad and smooth. On the other hand, it can be seen from FIG. 16B that the base profile, which is considered to be the amorphous profile of Comparative Example 1, has a characteristic differing from that of the amorphous profile actually measured.

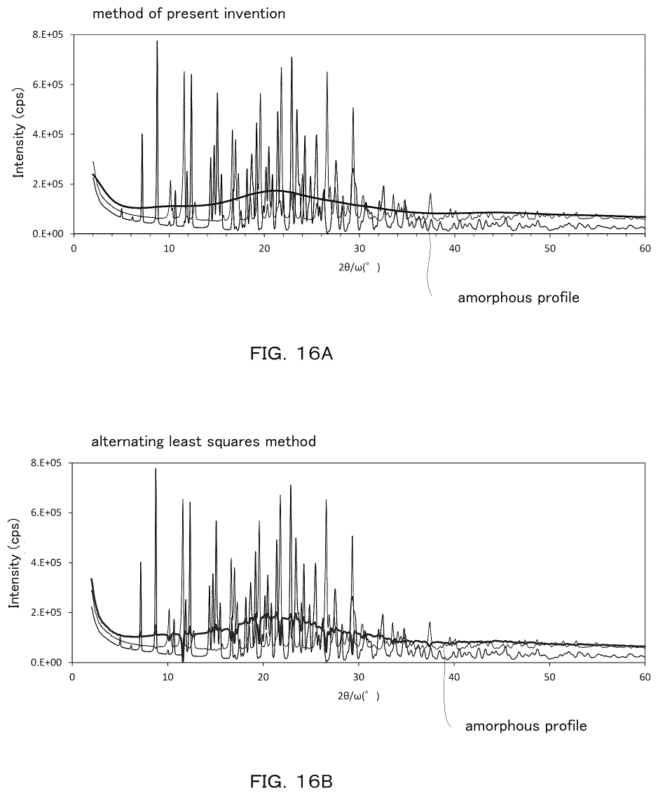

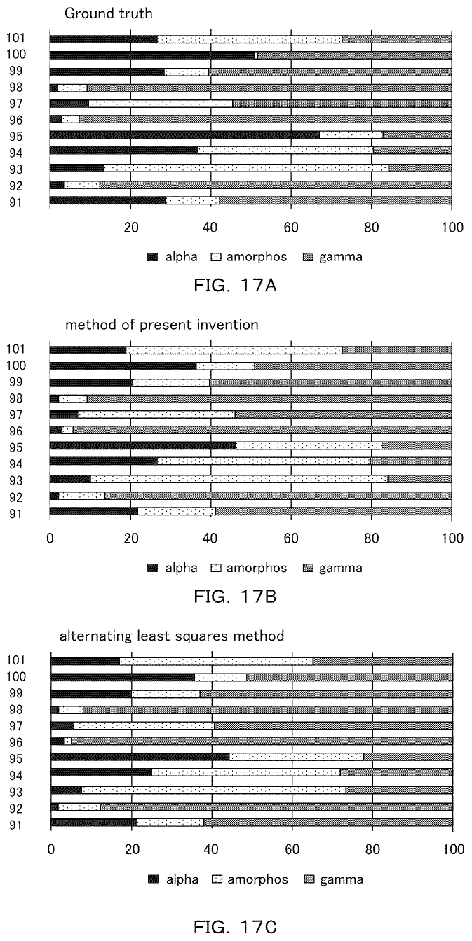

Next, the quantitative analysis was applied to the content ratios of indomethacin α type, indomethacin y type and amorphous in Samples 91 to 101 using the respective base profiles calculated in Example 1 or Comparative Example 1. Samples 91 to 101 were mixtures in which the contents of the respective components were known, and the respective content ratios were defined as true (Ground truth). FIGS. 17A to 17C are graphs showing the true content ratios of Samples 91 to 101, the analysis results according to Example 1, and the analysis results according to Comparative Example 1, respectively.

The residual mean squared error (MSE) between the analytical results of Example 1 or Comparative Example 1 and the true content ratio was calculated. Consequently, MSE of Example 1 was 57.30, and MSE of Comparative Example 1 was 60.57. As a result, it was found that the analysis result of the method of the present disclosure is closer to the true content ratio than the analysis result of the conventional method. That is, it was confirmed that the method of the present disclosure has high accuracy even in quantitative analysis.

### Example 2

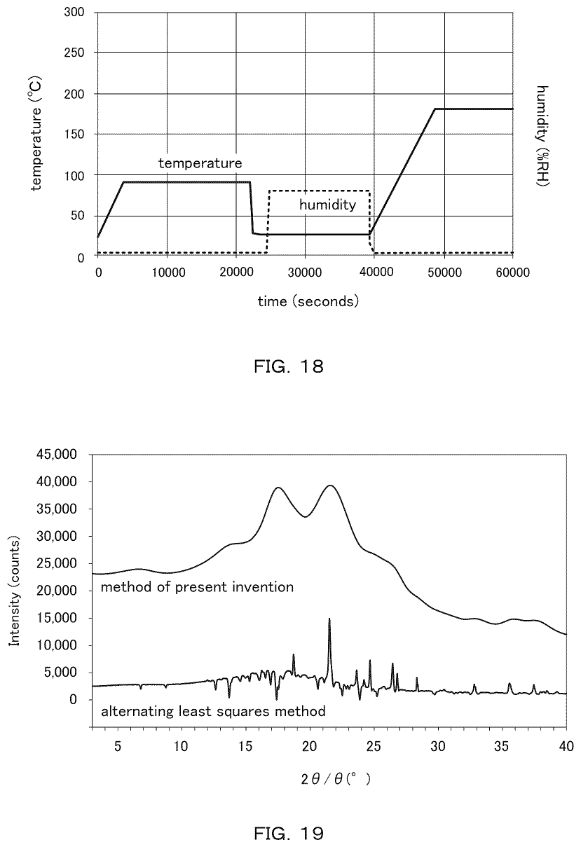

Next, using a similar system 100, trehalose was placed on a sample stage capable of changing temperature and humidity, and a plurality of X-ray diffraction data were measured while changing temperature and humidity over time. FIG. 18 is a graph showing time changes in temperature and humidity of an environment in which samples of Example 2 and Comparative Example 2 are placed. For the measured profiles, the method of the present disclosure was used to calculate the base profiles of trehalose amorphous, dihydrate, anhydrate a, and anhydrate B. Specifically, each base profile was calculated by setting the hyper parameter to 4 and setting the end condition to 200 repetitions, performing non-negative matrix factorization and correcting the base profile considered to be an amorphous profile.

### Comparative Example 2

For the same measured profiles, the hyper parameter was set to 4 using the alternate least squares method and a non-negative matrix factorization decomposition was performed to calculate the base profile of amorphous, dihydrate, anhydride α and anhydride β of trehalose.

FIG. 19 is a graph showing the base profiles of amorphous materials of Example 2 and Comparative Example 2, respectively. FIG. 19 shows that the amorphous base profile is broad and smooth in Example 2. On the other hand, it can be seen that the base profile of the amorphous of Comparative Example 2 has a feature, in which a fine peak is observed, different from that of the amorphous actually measured.

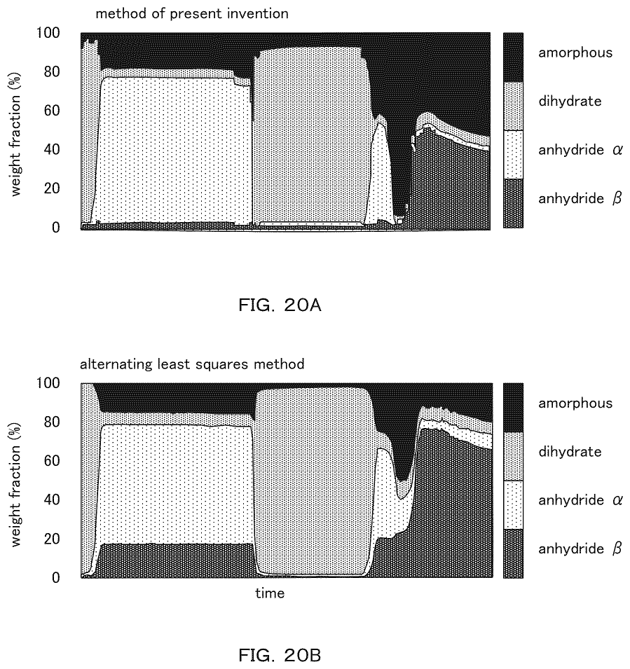

Using the respective base profiles calculated in Example 2 or Comparative Example 2, the change over time in the content ratio of trehalose was obtained. FIGS. 20A and 20B are graphs showing the analysis results according to Example 2 and the analysis results according to Comparative Example 2, respectively. For trehalose, the following are known:
(1) The dihydrate is converted to anhydride β by heating at 140° C.
(2) Heating the dihydrate under normal humidity results in an amorphous transition.
(3) When the amorphous is heated, it is transformed to anhydride β at 150° C.
(4) When the anhydride β is heated, it melts at 210° C. and transforms to amorphous.

From these results, it was confirmed that the accuracy of the quantitative analysis was higher in Example 2 in which anhydride β hardly appeared unless it became 140° C. or higher than in Comparative Example 2 in which anhydride β was observed at a temperature of 100° C. or lower.

From the above results, it was confirmed that the processing apparatus, the system, the method, and the program of the present disclosure can improve the accuracy of the decomposition by performing non-negative matrix factorization to the measured profiles of the X-ray powder diffraction and correcting at least some of the base profiles.

The functionality of the elements disclosed herein may be implemented using circuitry or processing circuitry which includes general purpose processors, special purpose processors, integrated circuits, ASICs (“Application Specific Integrated Circuits”), FPGAS (“Field Programmable Gate Arrays”), conventional circuitry and/or combinations thereof which are programmed, using one or more programs stored in one or more memories, or otherwise configured to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein which is programmed or configured to carry out the recited functionality.

### DESCRIPTION OF SYMBOLS

100 system
200 X-ray diffraction apparatus
210 X-ray generating section
220 Incident side optical unit
230 goniometer
240 sample stage
250 emitting side optical unit
260 detector
300 control apparatus
310 control section
320 apparatus information storing section
330 measurement data storing section
340 display section
400 processing apparatus
410 measured profile acquiring section
415 Dendrogram generating section
420 decomposition section
430 index calculating section
435 number-of-profiles setting section
440 base profile classifying section
450 base profile correcting section
460 peak search section
470 identification section
480 quantification section
510 input device
520 display device

What is claimed is:

1. A processing apparatus for processing measured profiles of X-ray powder diffraction, the processing apparatus comprising:
processing circuitry configured to
acquire a plurality of measured profiles of X-ray powder diffraction,
apply non-negative matrix factorization to the measured profiles and calculate base profiles,
acquire the base profiles and calculate indexes based on unevenness of the base profiles,
classify the base profiles into a plurality of groups based on the indexes, and
perform correction based on the indexes on at least one of the plurality of groups and calculate corrected base profiles.

2. The processing apparatus according to claim 1, wherein the processing circuitry is further configured to
apply non-negative matrix factorization to the measured profiles using the corrected base profiles as an initial condition.

3. The processing apparatus according to claim 1,
wherein the indexes are relative total variations (RTVs).

4. The processing apparatus according to claim 1,
wherein the plurality of groups are two groups, and the group for performing correction based on the indexes is a group including the base profile derived from an amorphous material.

5. The processing apparatus according to claim 1, wherein the processing circuitry is further configured to
set a number of the base profiles included in a group that performs correction based on the indexes.

6. The processing apparatus according to claim 3, wherein one of the corrections is a correction in which the RTVs are reduced.

7. The processing apparatus according to claim 1, wherein the processing circuitry is further configured to
calculate a statistic among the plurality of measured profiles to generate a dendrogram, and
apply non-negative matrix factorization to a cluster including a group of similar profiles selected by the processing apparatus from the dendrogram or selected by a user.

8. The processing apparatus according to claim 1, wherein the processing circuitry is further configured to
performing a peak search on the base profile after the non-negative matrix factorization, generate a d-I list, and perform qualitative analysis using the d-I list.

9. The processing apparatus according to claim 8, wherein the processing circuitry is further configured to perform quantitative analysis using the data performed the qualitative analysis.

10. A system comprising a processing apparatus according to claim 1, further comprising:
an X-ray diffraction apparatus including an X-ray source for generating X-rays, a detector for detecting X-rays and a goniometer for controlling the rotation of the sample.

11. A method for processing measured profiles of X-ray powder diffraction, the method comprising:
acquiring a plurality of measured profiles of X-ray powder diffraction;
applying non-negative matrix factorization to the measured profiles and calculating base profiles;
acquiring the base profiles and calculating indexes based on unevenness of the base profiles;
classifying the base profiles into a plurality of groups based on the indexes; and
performing correction based on the indexes on at least one of the plurality of groups and calculating corrected base profiles.

12. A non-transitory computer readable recording medium having recorded thereon a program for processing measured profiles of X-ray powder diffraction, the program causing a computer to perform:
acquiring a plurality of measured profiles of X-ray powder diffraction;
applying non-negative matrix factorization to the measured profiles and calculating base profiles;
acquiring the base profiles and calculating indexes based on unevenness of the base profiles;
classifying the base profiles into a plurality of groups based on the indexes; and
performing correction based on the indexes on at least one of the plurality of groups and calculating corrected base profiles.
